(19) United States
(12) Patent Application Publication
(10) Pub. No.: US 2018/0187066 A1
(43) Pub. Date: Jul. 5, 2018

(54) DELAYED REACTION TREATMENT ADDITIVE

(71) Applicant: Halliburton Energy, Houston, TX (US)

(72) Inventors: Sushant Dattaram Wadekar, Pune, Maharashtra (IN); Shoy George Chittattukara, Thrissur, Kerala (IN); Rajender Salla, Pune, Maharashtra (IN)

(21) Appl. No.: 15/740,403

(22) PCT Filed: Jul. 29, 2015
(86) PCT No.: PCT/US2015/042717

§ 371 Date: Dec. 28, 2017

(51) Int. Cl. C09K 8/575; C09K 8/28

(52) U.S. Cl. CPC C09K 8/5755; E21B 43/261; C09K 8/28

(57) ABSTRACT

A delayed reaction treatment additive for treating a subterranean formation penetrated by a wellbore is provided. The treatment additive includes a clay sensitive multi-internal phase macro-emulsion formed using a cationic emulsifier and having an internal phase and an aqueous-based continuous phase. The internal phase of the macro-emulsion includes a delayed reaction treating agent. The treating agent includes a first component and a second component that retain their separate identities in the macro-emulsion and are prevented from reacting until the emulsion breaks. The triggering agent for breaking the emulsion is clay. A method of treating a subterranean formation penetrated by a wellbore with a delayed reaction treatment additive is also provided.

### BACKGROUND

The process of recovering hydrocarbons such as oil and gas from a subterranean formation entails numerous steps, including drilling a wellbore into a producing zone of the formation, completing the well and producing the hydrocarbons from the formation. Completing a well typically involves the design, selection, and installation of equipment and materials in or around the wellbore necessary or desirable for conveying, pumping, and/or controlling the injection or production of fluids. After the well has been completed, production of formation fluids can begin.

Various treatments are typically carried out on a well during the drilling phase, completion of the well or otherwise prior to placing the well in production. After a well has entered the production stage, one or more treatments are often carried out on the well to increase the rate of production of hydrocarbons from the well.

In order to efficiently produce hydrocarbons from a subterranean formation, the formation must be sufficiently conductive in order to allow the hydrocarbons to flow to the wellbore. Various treatments for assuring or increasing the conductivity of a formation have been developed.

One type of treatment often carried out on wells involves consolidating unconsolidated particulates in the formation (for example, formation fines and sand) in order to minimize flow back of the unconsolidated particulates together with the desired hydrocarbon(s) into the wellbore. For example, when the subterranean formation is weakly consolidated, small particulates (typically sand) present in the formation may dislodge and travel along with the produced fluid to the wellbore. Flow back of unconsolidated particulates into the wellbore (referred to herein as “particulate migration”) can clog conductive channels in the formation, damage the interior of the formation and otherwise adversely impact the fluid conductivity of the formation and production of hydrocarbons from the formation. Particulate migration can also damage equipment used, for example, to produce hydrocarbons from the well. As used herein, the term “unconsolidated particulates” includes unconsolidated particulates as well as weakly and loosely consolidated particulates.

Treatments to consolidate unconsolidated particulates can be carried out, for example, during the drilling stage, during completion of the well and/or after production of the well has started. For example, treatments can be carried out to consolidate unconsolidated portions of a formation during the drilling process. For example, sand consolidation treatments can be carried out on a formation during the completion phase of the drilling process. By way of further example, consolidation treatments can be carried out in connection with or after hydraulic fracturing treatments carried out on a formation either before or after production of the well has started.

Hydraulic fracturing operations generally involve pumping a treatment fluid (for example, a fracturing fluid or a “pad” fluid) into the wellbore at a sufficient hydraulic pressure to create or enhance one or more fractures in the formation. The fracturing fluid may comprise particulates, often referred to as “proppant particulates,” that are deposited in the resultant fractures. For example, sand is commonly used as a proppant particulate. The term “propped fracture” as used herein refers to a fracture (naturally-occurring or otherwise) in a subterranean formation that contains a plurality of proppant particulates. The term “proppant pack” refers to a collection of proppant particulates within a fracture. The proppant particulates prevent the fractures from fully closing upon the release of hydraulic pressure, thereby forming conductive channels through which the fluids may flow to the wellbore. Unfortunately, the gain in production achieved by a hydraulic fracturing operation can be offset by an increase in particulate migration due to the proppant particulates, residue created by the fracturing treatment and otherwise due to the fracturing treatment.

An example of an additional problem that can negatively impact conductivity and further complicate the effects of particulate migration is the tendency of mineral surfaces in a subterranean formation to undergo chemical reactions caused, at least in part, by conditions created by mechanical stresses on those minerals (for example, stresses created by fracturing mineral surfaces and compaction of mineral particulates). These reactions, referred to herein as “stress-activated reactions” or “stress-activated reactivity,” can form formation particulates.

There are several known techniques used to control particulate migration, some of which involve the use of a consolidating agent. As used herein, the term “consolidating agent” means any compound, combination of compounds or component that is capable of minimizing particulate migration in a subterranean formation and/or modifying the stress-activated reactivity of subterranean fracture faces and other surfaces in a subterranean formation.

For example, particulate migration can be controlled by using a consolidating agent to coat unconsolidated particulates (including, for example, naturally occurring particulates and proppant particulates) in the formation, which causes the particulates to adhere to one another making them less likely to migrate through the conductive channels in the subterranean formation and into the wellbore. For example, an unconsolidated portion of a subterranean formation can be consolidated into a relatively stable permeable mass by applying a consolidating agent to the unconsolidated portion.

Particulate migration can also be controlled by using consolidating agents in connection with gravel packing operations. Gravel packing involves the placement of a filtration bed of gravel particulates in the subterranean formation that acts as a barrier to prevent particulates from flowing into the wellbore. A consolidating agent may be used to bind the gravel particulates together in order to form a porous matrix through which formation fluids can pass.

An example of a consolidating agent that can be used is a two-component epoxy-based resin system including an epoxy resin and a hardening agent for reacting with and curing the resin. For example, the resin component can first be introduced to the formation. Following the addition of a spacer fluid to the formation, an external hardening agent component can then be added to the formation to react with and cure the resin. By separately placing the resin and the hardening agent component in the formation, premature reaction of the resin and hardening agent (for example, in the wellbore) can be avoided. The terms “catalyst,” “hardening agent,” “hardening agent component,” “hardener” and “curing agent” may be used herein interchangeably and individually or collectively to refer to a composition that affects the hardening of a resin composition by any means or mechanism.

### BRIEF DESCRIPTION OF THE DRAWINGS

FIG. 1 is a flow diagram showing preparation and use of the dual internal phase emulsion disclosed herein.

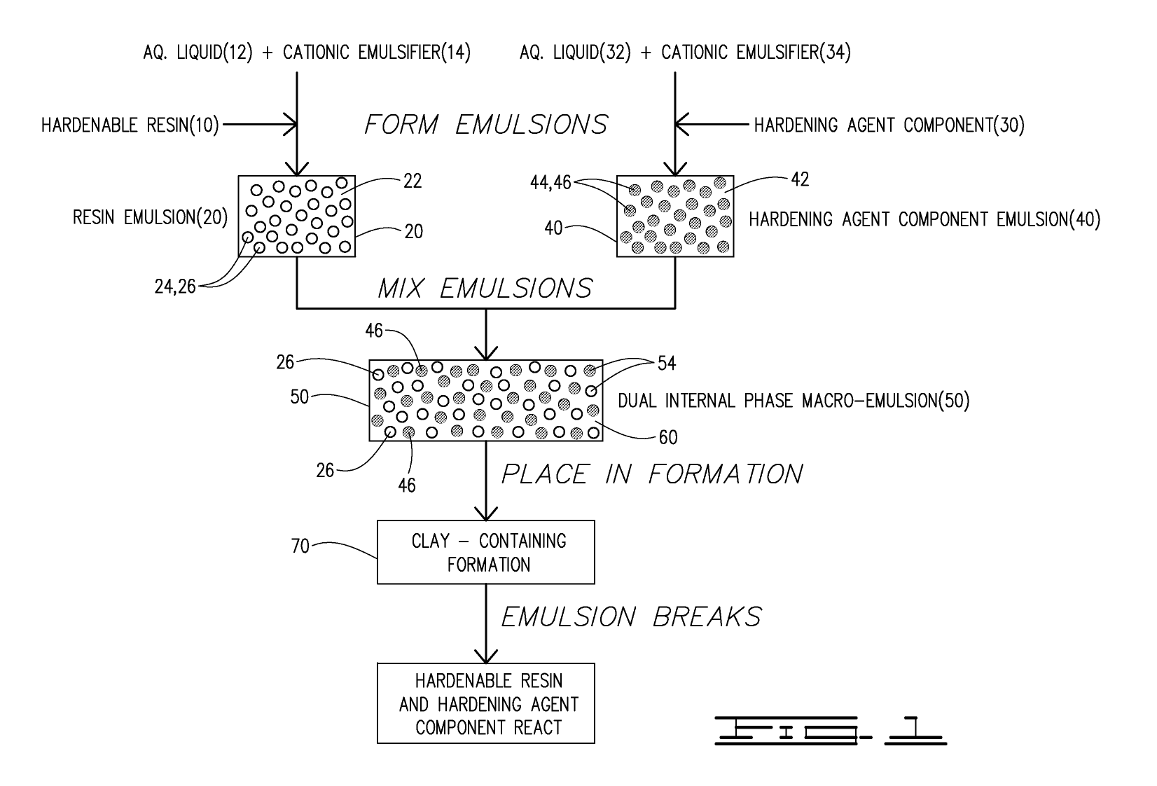

FIG. 2 is a schematic diagram of an exemplary wellbore drilling assembly and various associated components or pieces of equipment.

### DETAILED DESCRIPTION

The present disclosure may be understood more readily by reference to this detailed description as well as to the example(s) included herein. For simplicity and clarity of illustration, where appropriate, reference numerals may be repeated among the different figures to indicate corresponding or analogous elements. In addition, numerous specific details are set forth in order to provide a thorough understanding of the examples described herein. However, it will be understood by those of ordinary skill in the art that the examples described herein can be practiced without these specific details. In other instances, methods, procedures and components have not been described in detail so as not to obscure the related relevant feature being described. Also, the description is not to be considered as limiting the scope of the examples described herein. The drawings are not necessarily to scale and the proportions of certain parts have been exaggerated to better illustrate details and features of the present disclosure.

In one aspect of this disclosure, a delayed reaction treatment additive for treating a subterranean formation penetrated by a wellbore is provided. In one example, the treatment additive includes a consolidating agent. In another aspect of this disclosure, a method of treating a subterranean formation penetrated by a wellbore with a delayed reaction treatment additive is provided. In one example, the treatment additive used in the method includes a consolidating agent.

### Delayed Reaction Treatment Additive

The delayed reaction treatment additive for treating a subterranean formation penetrated by a wellbore comprises a clay sensitive multi-internal phase macro-emulsion formed using a cationic emulsifier and having an internal phase and an aqueous-based continuous phase. The internal phase includes a delayed reaction treating agent. The delayed reaction treating agent includes: (a) a plurality of first droplets dispersed in the internal phase, each of the first droplets containing a water insoluble, liquid first component; and (b) a plurality of second droplets dispersed in the internal phase, each of the second droplets containing a water insoluble, liquid second component capable of reacting with the first component. The first droplets and the second droplets retain their separate identities and prevent the first component and the second component from reacting until the emulsion breaks. As a result, the reaction of the treating agent and treatment of the formation with the treatment additive is delayed until the emulsion breaks. Once the macro-emulsion breaks, the first and second components contact one another and react allowing the treating agent and treatment additive to treat the formation as intended.

As used herein, the term “macro-emulsion” refers to a mixture of two or more immiscible liquids wherein at least one of the liquids or phase is dispersed as droplets forming a discontinuous phase inside another liquid or phase that forms the continuous phase. The term “multi-internal phase macro-emulsion” means a macro-emulsion that has an internal phase that includes at least two separate types of droplets, each separate type of droplet retaining its identity until the macro-emulsion breaks. For example, the multi-internal phase macro-emulsion can have two separate types of droplets and thereby be a dual internal phase macro-emulsion.

As used herein, a “clay sensitive” macro-emulsion means a macro-emulsion that breaks upon contact with clay. As used herein, a macro-emulsion “breaks” when it inverts or otherwise comes apart causing the separate droplets in the dispersed phase to collapse and come into contact with one another.

The nature of the separate water insoluble components (for example, the water insoluble liquid first component and the water insoluble liquid second component) and the amounts thereof that are utilized to form the macro-emulsion and the delayed reaction treating agent can vary depending on the nature of the components, the type of reaction desired and other factors that will be understood by those skilled in the art in view of this disclosure. The amount of clay needed to break the emulsion will depend on the type and concentration of cationic emulsifying agent in the macro-emulsion and the conditions and parameters associated with the treatment, including the associated temperature, pressure, pumping rate, etc.

For example, a dual internal phase macro-emulsion can be prepared by: (a) preparing a first oil in water emulsion by emulsifying a water insoluble, liquid first component in a first aqueous liquid containing a cationic emulsifier; (b) preparing a second oil in water emulsion by emulsifying a water insoluble, liquid second component capable of reacting with the first component in a second aqueous liquid containing a cationic emulsifier, the first aqueous liquid and the second aqueous liquid being the same or at least compatible with one another; and (c) mixing the first emulsion and the second emulsion together.

For example, the first and second aqueous liquids used to form the macro-emulsion can be the same. The cationic emulsifiers contained by the first and second aqueous liquids can be the same or at least compatible with one another. For example, the cationic emulsifier contained by the first aqueous liquid and the cationic emulsifier contained by the second aqueous liquid are the same. For example, the water insoluble first and second components can be emulsified into the corresponding aqueous liquid by blending the involved components together at a high shear rate using a high shear rate blender.

The first and second emulsions are physically mixed together. The first and second emulsions can be physically mixed together by mixing at a shear rate that is lower than the shear rate used to emulsify the first and second components into the corresponding aqueous liquid. For example, upon mixing the first emulsion and the second emulsion together, a dual internal phase macro-emulsion having a plurality of first droplets and a plurality of second droplets dispersed in the internal phase and an aqueous-based continuous phase is formed. The dispersion of the first and second droplets in the internal phase is stabilized by the cationic emulsifier(s). The first and second aqueous liquids are used to form the aqueous-based continuous phase of the macro-emulsion. Due to ionic repulsion or stearic factors, for example, a barrier is created that keeps the first and second droplets in the dispersed phase from collapsing and merging together until the macro-emulsion breaks.

As will be understood by those skilled in the art in view of this disclosure, a macro-emulsion having three or more separate types of droplets dispersed in the internal phase can be prepared in the same manner. For example, a third oil in water emulsion can also be prepared by emulsifying a water insoluble, liquid third component in a third aqueous liquid (that is the same or at least compatible with the first and second aqueous liquids) containing a cationic emulsifier (that is the same or at least compatible with the cationic emulsifier(s) contained by the first and second aqueous liquids), and mixing the third emulsion with the first and second emulsions.

For example, the first and second emulsions (and third or forth, etc. if more than two emulsions are used) can by physically mixed together to form the multi-internal phase macro-emulsion and combined with a carrier fluid on the fly as the treatment fluid is injected into a wellbore. The term “on the fly” is used herein to mean that a flowing stream is continuously introduced into another flowing stream so that the streams are combined and mixed while continuing to flow as a single stream.

While not intending to be bound to any particular theory or mode of operation, it is believed that the use of cationic emulsifiers in forming the first and second (and optionally additional) oil in water emulsions is the fundamental reason that the overall macro-emulsion is clay sensitive. For example, it is believed that the cationic emulsifier(s) in the macro-emulsion adsorb on negatively charged surfaces of clay particles. Once a sufficient amount of cationic emulsifier is depleted from the macro-emulsion due to adsorption of the cationic emulsifier on negatively charged clay surfaces, the macro-emulsion will become destabilized and break. Clay (for example, formation clay) is the triggering agent for breaking the macro-emulsion. The use of clay as the triggering agent for breaking the macro-emulsion allows the macro-emulsion to be used over a broad range of temperatures (including bottom hole temperature), pH and other conditions. For example, in a typical use, the clay sensitive macro-emulsion will not break until it enters the formation.

For example, the aqueous liquid(s) used to prepare the macro-emulsion and the aqueous-based continuous phase of macro-emulsion can be fresh water, salt water, brine solutions, seawater and mixtures thereof. For example, the aqueous liquids used to prepare the macro-emulsion, and the aqueous-based continuous phase of the macro-emulsion, can each be a brine solution.

For example, where long-term stability of the macro-emulsion is desired, the aqueous liquids used to prepare the macro-emulsion and the aqueous-based continuous phase of macro-emulsion can be substantially free of salts. As used herein, “long term stability” refers to the ability of the macro-emulsion to remain stable over a period of at least one month. As used herein, the term “salts” is used in its ordinary meaning, referring to materials commonly used in the industry in the preparation of completion brines, and including materials such as potassium chloride, sodium chloride, ammonium chloride, and calcium chloride. It is within the ability of one skilled in the art with the benefit of this disclosure to determine if and how much salt may be tolerated in the macro-emulsion before it becomes problematic for the stability of the emulsion.

For example, the cationic emulsifier of the multi-internal phase macro-emulsion of the delayed reaction treatment additive disclosed herein and contained by the aqueous liquid(s) used to prepare macro-emulsion can be any cationic emulsifier that is capable of forming the macro-emulsion and that will be adsorbed on surfaces of clay particles.

For example, the cationic emulsifier can comprise one or more alkyl quaternary ammonium salts with at least one alkyl group having at least 12 carbon atoms, including alkyl quaternary ammonium salts selected from the group consisting of cocotrimethylammonium chloride, myristyltrimethylammonium chloride, cetyltrimethylammonium chloride, cetyltri-methylammonium bromide (CTAB), stearyltrimethylammonium chloride, tallowtrimethyl-ammonium chloride, soyatrimethylammonium chloride, erucyltrimethylammonium chloride, dicocodimethylammonium chloride, dimyristyldimethylammonium chloride, dicetyldimethyl-ammonium chloride, distearyldimethylammonium chloride, ditallowdimethylammonium chloride, dierucyldimethylammonium chloride, tricocomethylammonium chloride, tristearylmethylammonium, stearyl(bis)hydroxyethylmethylammonium chloride, coco(bis)-hydroxyethylmethylammonium chloride, stearyl(bis)polyethyleneglycolmethylammonium chloride, coco(bis) polyethyleneglycolmethylammonium chloride and mixtures thereof.

For example, the cationic emulsifier can also comprise one or more alkyl quaternary ammonium salts that include an amido-quaternary amine such as stearamidopropyl-trimethylammonium chloride, cocoamidopropyltrimethylammonium chloride, esterquats, and mixtures thereof. For example, suitable esterquats include fatty acid esters of mono-hydroxyethyltrimethyl ammonium chloride, dihydroxyethyldimethyl ammonium chloride, trihydroxyethylmethyl ammonium chloride and other fatty acid esters wherein the carbon number in the alkyl chain of the fatty acids is from 10 to 22.

For example, the cationic emulsifier can comprise one or more alkyl quaternary ammonium salts selected from the group consisting of cocotrimethylammonium chloride, cetyltrimethylammonium chloride, coco(cis)hydroxylethylmethylammonium chloride, stearamidopropyltrimethylammonium chloride, a fatty acid ester of monohydroxyethyltrimethyl ammonium chloride, and mixtures thereof. For example, the cationic emulsifier can be selected from the group consisting of cocotrimethylammonium chloride, cetyltrimethylammonium chloride, a stearic acid ester of monohydroxyethyltrimethyl ammonium chloride, and mixtures thereof.

For example, the cationic emulsifier can comprise a quaternary salt of an amine with all four groups substituted with alkyl groups and at least one of the alkyl groups having a carbon chain length of at least 12. The alkyl groups can be straight chain or branched chain and include one or more cycloaliphatic, aromatic, ester, ether or amide groups. One example of such a cationic surfactant is cetyl-trimethyl-ammonium bromide (CTAB, CAS 57-09-0).

For example, the cationic emulsifier is present in the macro-emulsion in an amount of less than about 10% by weight based on the total weight of the macro-emulsion. For example, the cationic emulsifier can be present in the macro-emulsion in an amount in the range of from about 0.005% to about 10% by weight based on the total weight of the macro-emulsion. For example, the cationic emulsifier can be present in the macro-emulsion in an amount in the range of from about 0.1% to 3% by weight based on the total weight of the macro-emulsion. For example, the cationic emulsifier is present in the macro-emulsion in an amount in the range of from about 1% to about 2% by weight based on the total weight of the macro-emulsion.

For example, the aqueous-based continuous phase can be present in the macro-emulsion in an amount in the range of about 20% to about 99.9% by weight based on the total weight of the macro-emulsion. For example, the aqueous-based continuous phase can be present in the macro-emulsion in an amount in the range of about 60% to about 99.9% by weight based on the total weight of the macro-emulsion. For example, the aqueous-based continuous phase can be present in the macro-emulsion in an amount in the range of about 90% to about 99.9% by weight based on the total weight of the macro-emulsion. The percentages given herein refer to the aqueous-based continuous phase as a percentage of the macro-emulsion, not as a percentage of the overall carrier fluid to which the treatment additive disclosed herein is added. Other ranges may be suitable as well, depending on the other components of the macro-emulsion.

The combined amount of the first and second (and optionally additional) water insoluble, liquid components contained by the first and second (and optionally additional) droplets dispersed in the internal phase of the macro-emulsion can be, for example, in the range of about 0.1% to about 80% by weight based on the total weight of the macro-emulsion. For example, the combined amount of the first and second (and optionally additional) components contained by the first and second (and optionally additional) droplets dispersed in the internal phase of the macro-emulsion can be present in the macro-emulsion in the range of about 0.1% to about 40% by weight based on the total weight of the macro-emulsion. For example, the combined amount of the first and second (and optionally additional) components contained by the first and second (and optionally additional) droplets dispersed in the internal phase of the macro-emulsion can be in the range of about 0.1% to about 10% by weight based on the total weight of the macro-emulsion. These percentages refer to the first and second components as a percentage of the macro-emulsion, not as a percentage of the overall carrier fluid to which the treatment additive disclosed herein can be added. The combined amount of the first and second (and optionally additional) components contained by the first and second (and optionally additional) droplets dispersed in the internal phase of the macro-emulsion will depend on the particular application including the nature of the components, the composition and/or temperature of the formation, the chemical composition of formations fluids, the flow rate of fluids present in the formation, the effective porosity and/or permeability of the formation, the pore throat size and distribution, and other factors that will be understood by one skilled in the art with the benefit of this disclosure.

### Treatment Additive Including Consolidating Agent

For example, the delayed reaction treating agent of the delayed reaction treatment additive disclosed herein can be a delayed reaction consolidating agent. In this example, the macro-emulsion can be a dual internal phase macro-emulsion. The first component contained by the first droplets dispersed in the internal phase of the macro-emulsion can be a resin component that includes a water insoluble, hardenable epoxy resin. The second component contained by the second droplets dispersed in the internal phase of the macro-emulsion can be a hardening agent component that includes a water insoluble hardening agent capable of curing the epoxy resin when brought into contact with the resin. The first droplets and the second droplets retain their separate identities and prevent the resin and hardening agent from reacting until the emulsion breaks.

Any type of water insoluble, hardenable epoxy resin and hardening agent that function to form a delayed reaction two-component epoxy-based resin system (wherein the epoxy resin does not cure until it comes into contact with the hardening agent component) can be utilized in connection with the treatment additive disclosed herein. The hardenable epoxy resin and hardening agent can each be in liquid or solid form. For example, at least one of the hardenable epoxy resin and hardening agent is a liquid. For example, both the hardenable epoxy resin and the hardening agent are liquids.

Examples of water insoluble, liquid, hardenable epoxy resins that can be used in the resin component include, but are not limited to, organic resins such as bisphenol A diglycidyl ether resins, butoxymethyl butyl glycidyl ether resins, bisphenol A-epichlorohydrin resins, bisphenol F resins, polyepoxide resins, novolak resins, polyester resins, phenol-aldehyde resins, urea-aldehyde resins, furan resins, urethane resins, glycidyl ether resins, other epoxide resins, and mixtures thereof. Additional examples of water insoluble, liquid, hardenable epoxy resins that can be used in the resin component include, but are not limited to, glycerol diglycidyl ether, glycerol triglycidyl ether, 1,6-hexanediol diglycidyl ether, 1,4-butanediol diglycidyl ether, cyclohexanedimethanol diglycidyl ether, 1,1,1-trimethylolpropane polyglycidyl ether, diethyleneglycol diglycidyl ether, a diglycidyl ether of pentaerythritol, neopentyl glycol diglycidyl ether, cyclohexanedimethanol diglycidyl ether, trimethylolethane triglycidyl ether, ethylene glycol diglycidyl ether, dibromo neopentyl glycol diglycidyl ether, propoxylated glycerin triglycidyl ether, polyglycerol-3-polyglycidyl ether, sorbitol polyglycidyl ether, glycerol triglycidyl ether, triphenylolmethane triglycidyl ether, 1,1,1-tris(4-hydroxyphenyl)ethane triglycidyl ether, triglycidyl-p-aminophenol, trimethylolpropane triglycidyl ether, 1,3,5-triglycidyl-isocyanurate, (R,R,R)-triglycidyl isocyanurate, isocyanuric acid (S,S,S)-triglycidyl ester, glycerol propoxylate triglycidyl ether, N,N-diglycidyl-4-glycidyloxyaniline, 2,4,6-tris(oxiranylmethoxy)-1,3,5-triazine, triglycidyl-m-aminophenol, triglycidyl-4-amino-m-cresol, triglycidyl-5-amino-o-cresol, pentaerythritol tetraglycidyl ether, 4-(3,3-dihydroxy-2,4,4-trimethyl-2H-1-benzopyran-2-yl)-1,3-benzenediol glycidyl, tris(4-hydroxyphenyl)methane triglycidyl ether, N,N-diglycidyl-2-chloro-4-[2-chloro-N-glycidyl aniline methyl]aniline, tetra-functional o-glycidyl resin, tetraglycidyl-4,4′-methylenediamine, tetraglycidyl-4,4′-dimethyl-dianiline, N,N,N,N′-tetraglycidyl-m-xylenediamine, tetraglycidylmethylenedianiline, and mixtures thereof.

For example, the water insoluble, liquid, hardenable epoxy resin can be selected from the group of bisphenol A-epichlorohydrin resins, glycerol diglycidyl ether, 1,1,1-trimethylolpropane polyglycidyl ether, and mixtures thereof. For example, the water insoluble, liquid, hardenable epoxy resin can be a bisphenol A-epichlorohydrin resin.

One example of a commercially available water insoluble, liquid, hardenable epoxy resin that can be used is sold by Halliburton Energy Services, Inc. of Duncan, Oklahoma in association with the trademark “SandTrap™ 225A”. Another example of a commercially available water insoluble, liquid, hardening agent that can be used is sold by Halliburton Energy Services, Inc. of Duncan, Oklahoma in association with the trademark “Expedite® 225B”. Other examples of commercially available water insoluble, liquid, hardenable epoxy resins that can be used are green epoxy resins sold by EcoPoxy™ Systems of Morris Manitoba, Canada.

The water insoluble, liquid, hardenable epoxy resin can be included in the resin component in an amount in the range of about 5% to about 100% by weight based on the total weight of the resin component. It is within the ability of one skilled in the art with the benefit of this disclosure to determine how much of the resin component may be needed to achieve the desired results. Factors that may affect this decision include which type of water insoluble, liquid, hardenable epoxy resin and water insoluble, liquid hardening agent are used.

In addition to the water insoluble, liquid, hardenable epoxy resin, the resin component can optionally include a solvent. The solvent may be added to the resin component to liquify the hardenable epoxy resin (if a solid epoxy resin is used) and/or reduce the viscosity of the resin (even if a liquid epoxy resin is used) for ease of handling, mixing and transferring and also for ease of emulsifying. It is within the ability of one skilled in the art with the benefit of this disclosure to determine if and how much solvent may be needed to achieve a viscosity suitable to the subterranean conditions. Factors that may affect this decision include geographic location of the well, the surrounding weather conditions, and the desired long-term stability of the consolidating agent emulsion. An alternate way to reduce the viscosity of the hardenable resin is to heat it.

Any solvent that is compatible with the hardenable epoxy resin and achieves the desired viscosity effect is suitable for use in the resin component. Suitable solvents include paraffinic oils, diesel, kerosene, liquid aliphatic alkanes (for example, octane, nonane, decane, dodecane, hexadecane etc.), cycloaliphatic solvents (for example, cyclohexane), aromatic solvents (for example, benzene, toluene, xylene, naphthalene etc.), esters of carboxylic acids with carbon numbers in the range of 2-22, alcohols with carbon numbers in range of 2-22, butyl lactate, dipropylene glycol methyl ether, dipropylene glycol dimethyl ether, dimethyl formamide, diethylene glycol methyl ether, ethylene glycol butyl ether, diethylene glycol butyl ether, propylene carbonate, methanol, butyl alcohol, d-limonene, fatty acid methyl esters, and mixtures thereof. Other suitable solvents include aqueous dissolvable solvents such as, methanol, isopropanol, butanol, glycol ether solvents, and mixtures thereof. Suitable glycol ether solvents include, but are not limited to, diethylene glycol methyl ether, dipropylene glycol methyl ether, 2-butoxy ethanol, ethers of a C₂ to C₆ dihydric alkanol containing at least one C₁ to C₆ alkyl group, mono ethers of dihydric alkanols, methoxypropanol, butoxyethanol, hexoxyethanol, and isomers thereof. Selection of an appropriate solvent is dependent on the resin component and hardening agent component utilized and is within the ability of one skilled in the art with the benefit of this disclosure.

For example, the amount of the solvent used in the resin component can be in the range of about 0.1% to about 30% by weight based on the total weight of the resin component.

Any suitable water insoluble, liquid hardening agent capable of curing the epoxy resin can be used in the hardening agent component. Examples of suitable water insoluble, liquid hardening agents include, but are not limited to, amines including cyclo-aliphatic amines such as piperazine, derivatives of piperazine (e.g., aminoethylpiperazine) and modified piperazines, aromatic amines, such as methylene dianiline, derivatives of methylene dianiline and hydrogenated forms thereof and 4,4′-diaminodiphenyl sulfone, aliphatic amines such as ethylene diamine, diethylene triamine, triethylene tetraamine, and tetraethylene pentaamine, imidazole, pyrazole, pyrazine, pyrimidine, pyridazine, 1H-indazole, purine, phthalazine, naphthyridine, quinoxaline, quinazoline, phenazine, imidazolidine, cinnoline, imidazoline, 1,3,5-triazine, thiazole, pteridine, indazole, amines, polyamines, amides, polyamides, 2-ethyl-4-methyl imidazole, and combinations thereof.

Examples of additional suitable water insoluble, liquid hardening agents that can be used in the resin component include, but are not limited to, cyclo-aliphatic amines (for example, piperazine derivatives of piperazine (such as aminoethylpiperazine), modified piperazines, hydrogenated methylene dianiline, imidazolidine, imidazoline and the like), an aromatic amine (for example, methylene dianiline, derivatives of methylene dianiline, 4,4′-diaminodiphenyl sulfone, and the like), an imidazole, a pyrazole, 1H-indazole, a purine, an indazole, an amine, a polyamine, a polyimine, an amide, a polyamide, a 2-ethyl-4-methyl imidazole, and any mixture thereof.

For example, the water insoluble, liquid hardening agent can be a cyclo-aliphatic amine. For example, the water insoluble, liquid hardening agent can be selected from the group of modified piperazines, aminoethylpiperazine, and mixtures thereof.

The water insoluble, liquid hardening agent used often affects the range of temperatures over which the hardenable epoxy resin is able to cure. By way of example and not of limitation, in subterranean formations having a temperature of about 60° F. to about 250° F., amines and cyclo-aliphatic amines such as piperidine, triethylamine, tris(dimethyl-aminomethyl)phenol, and dimethylaminomethyl)phenol may be more suitable. In subterranean formations having higher temperatures, 4,4′-diaminodiphenyl sulfone may be more suitable. Hardening agents that comprise piperazine or a derivative of piperazine have been shown capable of curing various hardenable epoxy resins from temperatures as low as about 50° F. to as high as about 350° F.

The water insoluble, liquid hardening agent can be included in the hardening agent component in an amount sufficient to at least partially harden the epoxy resin. For example, the hardening agent can be included in the hardening agent component in an amount in the range of about 0.1% to about 95% by weight based on the total weight of the hardening agent component. For example, the hardening agent used can be included in the hardening agent component in an amount in the range of from about 15% to about 85% by weight, based on the total weight of the hardening agent component. For example, the hardening agent can be included in the hardening agent component in an amount in the range of from about 15% to about 55% by weight based on the total weight of the hardening agent component.

One example of a commercially available water insoluble, liquid, hardening agent that can be used is sold by Halliburton Energy Services, Inc. of Duncan, Oklahoma in association with the trademark “SandTrap® 225B”. “SandTrap® 225B” hardening agent is very suitable for use in connection with “SandTrap® 225A” resin. Another example of a commercially available water insoluble, liquid, hardening agent that can be used is sold by Halliburton Energy Services, Inc. of Duncan, Oklahoma in association with the trademark “Expedite® 225B”. Expedite® 225B hardening agent is very suitable for use in connection with “Expedite® 225A” resin.

In addition to the water insoluble, liquid, hardening agent, the hardening agent component can optionally include a solvent. The solvent may be added to the hardening agent component to liquify the hardening agent (if a solid hardening agent is used) and/or reduce the viscosity of the hardening agent (even if a liquid hardening agent is used) for ease of handling, mixing and transferring and also for ease of emulsifying. It is within the ability of one skilled in the art with the benefit of this disclosure to determine if and how much solvent may be needed to achieve a viscosity suitable to the subterranean conditions. Factors that may affect this decision include geographic location of the well, the surrounding weather conditions, and the desired long-term stability of the consolidating agent emulsion. An alternate way to reduce the viscosity of the hardenable resin is to heat it.

Any solvent that is compatible with the hardening agent and achieves the desired viscosity effect is suitable for use in the hardening agent component. Suitable solvents include paraffinic oils, diesel, kerosene, liquid aliphatic alkanes (for example, octane, nonane, decane, dodecane, hexadecane etc.), cycloaliphatic solvents (for example, cyclohexane), aromatic solvents (for example, benzene, toluene, xylene, naphthalene etc.), esters of carboxylic acids with carbon numbers in the range of 2-22, alcohols with carbon numbers in range of 2-22, butyl lactate, dipropylene glycol methyl ether, dipropylene glycol dimethyl ether, dimethyl formamide, diethylene glycol methyl ether, ethylene glycol butyl ether, diethylene glycol butyl ether, propylene carbonate, methanol, butyl alcohol, d-limonene, fatty acid methyl esters, and mixtures thereof. Other suitable solvents include aqueous dissolvable solvents such as methanol, isopropanol, butanol, glycol ether solvents, and mixtures thereof. Suitable glycol ether solvents include, but are not limited to, diethylene glycol methyl ether, dipropylene glycol methyl ether, 2-butoxy ethanol, ethers of a C₂ to C₆ dihydric alkanol containing at least one C₁ to C₆ alkyl group, mono ethers of dihydric alkanols, methoxypropanol, butoxyethanol, hexoxyethanol, and isomers thereof. Selection of an appropriate solvent is dependent on the resin component and hardening agent component utilized and is within the ability of one skilled in the art with the benefit of this disclosure.

For example, the amount of the solvent used in the hardening agent component can be in the range of about 0.1% to about 30% by weight based on the total weight of the resin component.

The hardening agent component can also optionally include a silane coupling agent. The optional silane coupling agent may be used, among other things, to act as a mediator to help bond the resin to formation particulates. The term “silane coupling agent” as used herein refers to a compound having at least two reactive groups of different types bonded to a silicon atom. One of the reactive groups of different types is reactive with various inorganic materials such as glass, metals, silica sand and the like and may form a chemical bond with the surface of such inorganic materials, while the other of the reactive group is reactive with various kinds of organic materials and may form a chemical bond with the surface of such organic materials. As a result, silane coupling agents are capable of providing chemical bonding between an organic material and an inorganic material.

For example, in one example, the delayed reaction treatment additive for treating a subterranean formation penetrated by a wellbore comprises a clay sensitive multi-internal phase macro-emulsion formed using a cationic emulsifier and having an internal phase and an aqueous-based continuous phase. The internal phase includes a delayed reaction consolidating agent. The consolidating agent includes a plurality of first droplets dispersed in the internal phase, each of the first droplets containing a resin component that includes a water insoluble, liquid, hardenable epoxy resin, and a plurality of second droplets dispersed in the internal phase, each of the second droplets containing a hardening agent component that includes a water insoluble, liquid hardening agent capable of curing the epoxy resin when brought into contact with the resin. The first droplets and the second droplets retain their separate identities and prevent the resin and the hardening agent from reacting until the emulsion breaks.

For example, in this example, the cationic emulsifier used to form the macro-emulsion (for example, contained by the first and second aqueous liquids) is cetyl-trimethyl-ammonium bromide (CTAB, CAS 57-09-0). The water insoluble, liquid, hardenable epoxy resin is SandTrap™ 225A. The water insoluble, liquid hardening agent component is SandTrap™ 225B. In preparing the macro-emulsion, the epoxy resin (SandTrap™ 225A) and hardening agent (SandTrap™ 225B) can be emulsified in a brine solution (for example, a solution comprising 2% to 7% by weight KCl) using CTAB as the cationic emulsifier.

### Treatment Additive Including Delayed Reaction Thermosettable Polymer Composition

As another example, the treating agent of the delayed reaction treatment additive disclosed herein can be a delayed reaction thermosettable polymer composition. In this example, the first component is a water insoluble, liquid acrylate and/or acryl amide monomer, and the second component is a water insoluble, liquid amine based cross linker capable of reacting with the first component when brought into contact with the first component.

In this example, the delayed reaction treatment additive for treating a subterranean formation penetrated by a wellbore comprises a clay sensitive multi-internal phase macro-emulsion formed using a cationic emulsifier and having an internal phase and an aqueous-based continuous phase. The internal phase includes a thermosettable polymer composition. The thermo settable polymer composition includes a plurality of first droplets dispersed in the internal phase, each of the first droplets containing a water insoluble, liquid acrylate and/or acryl amide monomer, and a plurality of second droplets dispersed in the internal phase, each of the second droplets containing a water insoluble, liquid amine based cross linker capable of reacting with the acrylate and/or acryl amide monomer when brought into contact with the acrylate and/or acryl amide monomer. The first droplets and the second droplets retain their separate identities and prevent the acrylate and/or acryl amide monomer and the amine based cross linker from reacting until the emulsion breaks.

### Method of Treating Formation with Delayed Reaction Treatment Additive

The method of treating a subterranean formation penetrated by a wellbore with a delayed reaction treatment additive disclosed herein comprises: (a) providing a carrier fluid; (b) providing the delayed reaction treatment additive disclosed above; (c) mixing the treatment additive with the carrier fluid to form a treatment fluid; (d) introducing the treatment fluid into the wellbore and placing the treatment fluid into a portion of the subterranean formation to be treated that contains a sufficient amount of clay to break the macro-emulsion and allow the first component and the second component to come into contact with one another; and (e) allowing the treating agent to treat the formation.

For example, the carrier fluid provided in accordance with the disclosed method is an aqueous fluid. Suitable aqueous fluids that can be used include fresh water, salt water, brine and seawater. Additional aqueous fluids that do not adversely react with the other components used in accordance with the disclosed method can also be used.

For example, the carrier fluid can be a brine solution. For example, the carrier fluid can be a brine solution containing potassium chloride (KCl). Suitable aqueous fluids may contain salt concentrations, such as KCl concentrations, in the range of from about 2% (w/v) to about 16% (w/v) to, for example, satisfy the ionic balance needed to help control clay swelling and fines migration. It is within the ability of one skilled in the art with the benefit of this disclosure to determine if and how much salt may be desirable in the carrier fluid and treatment fluid disclosed herein.

Optionally, the carrier fluid provided in accordance with the disclosed method can comprise additional additives such as emulsion stabilizers, emulsion destabilizers, antifreeze agents, biocides, algaecides, pH control additives, oxygen scavengers, clay stabilizers, weighting agents and degradable fluid loss agents. For instance, an emulsion stabilizer may be beneficial when stability of the macro-emulsion is desired for a lengthened period of time or at specified temperatures. For example, the emulsion stabilizer can be an alcohol. For example, the emulsion stabilizer can be an alcohol such as butanol. Antifreeze agents may be beneficial to lower the freezing point of the treatment additive.

For example, additional additives may be included in the carrier fluid in an amount in the range of about 0.001% to about 10% by weight based on the total weight of the carrier fluid. One of ordinary skill in the art with the benefit of this disclosure will recognize that the compatibility of any given additive should be tested to ensure that it does not adversely affect the performance of the treatment additive.

For example, the carrier fluid can optionally be foamed. If so, a gas and a foaming agent surfactant can be added to the carrier fluid. As used herein, the term “foamed fluid” includes foamed and co-mingled fluids. For example, the use of a foamed fluid may be desirable to help the carrier fluid, among other things, provide enhanced and uniform placement of the treatment additive and/or to reduce the amount of aqueous fluid that is required, for example, in water sensitive subterranean formations.

Various gases can be used for foaming the carrier fluid. Suitable gases include, but are not limited to, nitrogen, carbon dioxide, methane, and mixtures thereof. One of ordinary skill in the art with the benefit of this disclosure will be able to select an appropriate gas that may be used for foaming the carrier fluid used in the method disclosed herein. For example, the gas may be present in the carrier fluid in an amount in the range of about 5% to about 98% by volume of the carrier fluid. For example, the gas may be present in the carrier fluid in an amount in the range of about 20% to about 80% by volume of the carrier fluid. The amount of gas to incorporate into the carrier fluid may be affected by factors including the viscosity of the carrier fluid and wellhead pressures involved in a particular application.

For example, the foaming agent surfactant can be a nonionic surfactant. For example, suitable foaming agent surfactants include HY-CLEAN (HC-2)™ surface-active suspending agent, PEN-5™ additive and AQF-2™ additive, all of which are commercially available from Halliburton Energy Services, Inc., of Duncan, Oklahoma. The cationic emulsifiers like CTAB used for stabilization of emulsion can also function as foaming agent. Additional examples of foaming agent surfactants that can be used include, but are not limited to, betaines, amine oxides, methyl ester sulfonates, alkylamidobetaines such as cocoamidopropyl betaine, alpha-olefin sulfonate, trimethyltallowammonium chloride, C₈ to C₂₂ alkylethoxylate sulfate and trimethyl-cocoammonium chloride. Other suitable foaming agent surfactants may be included as well, which will be known to those skilled in the art with the benefit of this disclosure.

For example, the carrier fluid provided in accordance with the present method may further comprise a weighting agent. Weighting agents are used to, among other things, increase the fluid density and thereby affect the hydrostatic pressure exerted by the fluid. Examples of suitable weighting agents include, but are not limited to, potassium chloride, sodium chloride, sodium bromide, calcium chloride, calcium bromide, ammonium chloride, zinc bromide, zinc formate, zinc oxide, and mixtures thereof.

Optionally, the carrier fluid may further comprise degradable fiber particles, or fibers. For example, fibers can be included in the carrier fluid to ensure the permeability of propped fractures. As the fibers degrade with time, the porosities of the propped fractures increase. The degradable particles are preferably substantially uniformly distributed throughout the carrier fluid and, in turn, the fractures. Over time, the fibers will degrade in situ, causing the fibers to substantially be removed from the proppant aggregates and to leave behind voids in any proppant packs and proppant pillars. These voids enhance the porosity of the proppant packs and proppant pillars, which may result in enhanced conductivity.

Generally, the fibers comprise a degradable material. Degradable materials that may be used in conjunction with the present disclosure include, but are not limited to, oil-degradable materials, degradable polymers, dehydrated compounds, and mixtures thereof. Such degradable materials are capable of undergoing an irreversible degradation downhole. The term “irreversible” as used herein means that the degradable material, once degraded downhole, should not recrystallize or reconsolidate, e.g., the degradable material should degrade in situ but should not recrystallize or reconsolidate in situ.

For example, the fibers can include oil-degradable materials. Suitable oil-degradable materials include oil-degradable polymers. Oil-degradable polymers that can be used can be either natural or synthetic polymers. Some particular examples include, but are not limited to, polyacrylics, polyamides, and polyolefins (such as polyethylene, polypropylene, polyisobutylene, and polystyrene). Other suitable oil-degradable polymers include those that have a melting point which is such that the polymer will dissolve at the temperature of the subterranean formation in which it is placed. An example is a wax material.

Suitable examples of degradable polymers that may be used as fibers include, but are not limited to, homopolymers and random, block, graft, and star- and hyper-branched polymers. Specific examples of suitable polymers include polysaccharides such as dextran or cellulose, chitin, chitosan, proteins, aliphatic polyesters, poly(lactide), poly(glycolide), poly(ε-caprolactone), poly(hydroxybutyrate), poly(anhydrides), aliphatic polycarbonates, poly(ortho esters), poly(amino acids), poly(ethylene oxide), polyphosphazenes, and mixtures thereof. Polyanhydrides are another type of particularly suitable degradable polymer that can be used. Examples of suitable polyanhydrides include poly(adipic anhydride), poly(suberic anhydride), poly(sebacic anhydride), and poly(dodecanedioic anhydride). Other suitable examples include but are not limited to poly(maleic anhydride) and poly(benzoic anhydride). One skilled in the art will recognize that plasticizers may be included in forming suitable polymeric degradable materials useful herein. The plasticizers are included in an amount sufficient to provide the desired characteristics, for example, more effective compatibility of the melt blend components, improved processing characteristics during the blending and processing steps, and control and regulation of the sensitivity and degradation of the polymer by moisture.

Suitable dehydrated compounds are those materials that will degrade over time when rehydrated. For example, a particulate solid dehydrated salt or a particulate solid anhydrous borate material that degrades over time may be suitable. Specific examples of particulate solid anhydrous borate materials that can be used include but are not limited to anhydrous sodium tetraborate (also known as anhydrous borax), and anhydrous boric acid. These anhydrous borate materials are only slightly soluble in water. However, with time and heat in a subterranean environment, the anhydrous borate materials react with the surrounding aqueous fluid and are hydrated. The resulting hydrated borate materials are substantially soluble in water as compared to anhydrous borate materials and as a result degrade in the aqueous fluid.

Blends of certain degradable materials and other compounds may also be suitable. One example of a suitable blend of materials is a mixture of poly(lactic acid) and sodium borate (the mixing of an acid and base can result in a neutral solution which may be desirable in some applications. Another example would include a blend of poly(lactic acid) and boric oxide. Another example of a suitable blend is a composite of poly(lactic acid) and calcium carbonate, both of which will go into solution once the poly(lactic acid) begins to degrade. In choosing the appropriate degradable material or materials, a relevant factor is the degradation products that will result. The degradation products should not adversely affect subterranean operations or components. The choice of degradable material also can depend, at least in part, on the conditions of the well, for example, the wellbore temperature. For instance, lactides have been found to be suitable for lower temperature wells, including those within the range of 60° F. to 150° F., and polylactides have been found to be suitable for wellbore temperatures above this range. Poly(lactic acid) and dehydrated salts may be suitable for higher temperature wells. Also, in some examples it may be important for the degradable material to degrade slowly over time as opposed to instantaneously. For example, it may be important for the degradable material to not substantially degrade until after the degradable material has been substantially placed in a desired location within a subterranean formation.

The specific features of the fiber may be chosen or modified to provide the high closure stress fractures with optimum conductivity. The fiber can be selected to have a size and shape similar to the size and shape of the proppant particulates to help maintain substantial uniformity within the mixture. It may also be important for the proppant particulates and the fiber to not segregate within the treatment fluids.

Whichever fiber is utilized, the fiber may have any shape, including, but not limited, platelets, shavings, flakes, ribbons, rods, strips, spheroids, toroids, pellets, tablets, or any other physical shape. The physical shape of the fiber should be chosen so as to enhance the desired shape and relative composition of the resultant voids within the proppant packs and/or proppant pillars. For example, a rod-like particle shape may be suitable in applications wherein channel-like voids are desired. One of ordinary skill in the art, with the benefit of this disclosure, will recognize the specific fibers and the preferred size and shape for a given application.

For example, from 10% to about 90% of the combined weight of the fiber and the proppant particulates included in the carrier fluid can be fibers. For example, from about 20% to about 70% of the combined weight of the fiber and the proppant particulates included in the carrier fluid can be fibers. For example, from about 25% to about 50% of the combined weight of the fiber and the proppant particulates included in the carrier fluid can be fibers. The amount of fibers used should not be such that, when degraded, an undesirable percentage of voids are created in the proppant packs and/or proppant pillars making such proppant packs and/or proppant pillars potentially ineffective in maintaining the integrity of the high closure stress fracture. One of ordinary skill in the art, with the benefit of this disclosure, will recognize an optimum concentration of fibers that provides desirable values in terms of enhanced conductivity or permeability without undermining the stability of the proppant packs and/or proppant pillars.

For example, the carrier fluid may further comprise a degradable fluid loss control agent. Degradable fluid loss control agents are used to, among other things, control leak off into a formation. Suitable degradable fluid loss control agents are generally degradable polymers including, but not limited to polysaccharides, chitins, chitosans, proteins, aliphatic polyesters, poly(lactides), poly(glycolides), poly(epsilon-caprolactones), poly(hydroxybutyrates), poly(anhydrides, aliphatic polycarbonates, poly(orthoesters), poly(amino acids), poly(ethylene oxides), polyphosphazenes, and mixtures thereof. For example, the carrier fluid may also comprise degradable hydratable gel particulates that can be broken down with breakers or through a change in pH.

Other additives to the carrier fluid may be suitable as well as might be recognized by one skilled in the art with the benefit of this disclosure.

As disclosed above, the delayed reaction treatment additive provided in accordance with the inventive method comprises a clay sensitive multi-internal phase macro-emulsion formed using a cationic emulsifier and having an internal and an aqueous-based continuous phase. The internal phase includes a delayed reaction treating agent. The treating agent includes: (a) a plurality of first droplets dispersed in the internal phase, each of the first droplets containing a water insoluble, liquid first component; and (b) a plurality of second droplets dispersed in the internal phase, each of the second droplets containing a water insoluble, liquid second component capable of reacting with the first component. The first droplets and the second droplets retain their separate identities and prevent the first component and the second component from reacting until the emulsion breaks.

The treatment additive can be mixed with the carrier fluid to form the treatment fluid by any means. In one example, the carrier fluid and the delayed reaction treatment additive can be mixed together on the fly to form the treatment fluid as the treatment fluid is injected into the wellbore. As is well understood by those skilled in the art, the treatment additive can also be mixed with the carrier fluid, for example, by batch mixing or partial batch mixing.

In another embodiment, the clay sensitive multi-internal phase macro-emulsion of the treatment additive can be formed on the fly as the treatment additive is mixed with the carrier fluid. For example, the first and second emulsions (and third, forth, etc. emulsions if more than two emulsions are used) can by physically mixed together to form the multi-internal phase macro-emulsion and combined with a carrier fluid on the fly as the treatment fluid is injected into a wellbore.

For example, the treatment additive can be mixed with the carrier fluid to form the treatment fluid in an amount in the range of from about 0.1% (w/v) to about 25% (w/v) of the carrier fluid. For example, the treatment additive can be mixed with the carrier fluid to form the treatment fluid in an amount in the range of from about 0.1% (w/v) to about 5% (w/v) of the carrier fluid.

The treatment fluid can be introduced into the wellbore and placed into a portion of the subterranean formation to be treated by pumping the treatment fluid into the wellbore and through the wellbore into the desired portion of the formation or by any other method as understood by those skilled in the art with the benefit of this disclosure. For example, a suitable device like a HT400 pump or coiled tubing can be used. For example, an open hole treatment can be used. The multi-internal macro-emulsion remains stable while it remains inside the wellbore and well equipment. However, once the treatment fluid contacts clay in the formation, the clay destabilizes the macro-emulsion thereby allowing the first and second components to interact with each other and function as intended.

As stated above, the amount of clay needed to break the macro-emulsion and allow the first and second components to come into contact with one another depends on concentration and type of cationic emulsifier in the macro-emulsion and the conditions and parameters associated with the treatment, including the associated temperature, pressure and injection rate of the fluid.

The treating agent is allowed to treat the formation by allowing the treatment fluid to remain in the formation until the desired treatment is achieved. For example, a particular formation zone in which the treatment is to be carried out can be shut in for a desired period of time to compete the reaction.

### Method of Treating Formation with Delayed Reaction Treatment Additive to Consolidate Unconsolidated Particulates Therein

For example, the method disclosed herein can be a method of treating a subterranean formation penetrated by a wellbore with a delayed reaction treatment additive to help minimize particulate migration. In this example, the delayed reaction treating agent included in the internal phase of the macro-emulsion is a delayed reaction consolidating agent. The consolidating agent includes a plurality of first droplets dispersed in the internal phase, each of the first droplets containing a resin component that includes a water insoluble, liquid, hardenable epoxy resin, and a plurality of second droplets dispersed in the internal phase, each of the second droplets containing a hardening agent component that includes a water insoluble, liquid hardening agent capable of curing the epoxy resin when brought into contact with the resin.

In this example, the treatment fluid is introduced into a portion of the subterranean formation that includes unconsolidated particulate material and that contains a sufficient amount of clay to break the macro-emulsion and allow the resin and the hardening agent to come into contact with one another. The consolidating agent is then allowed to at least partially consolidate at least a portion of the unconsolidated particulates.

In one embodiment, before or after the treatment fluid is introduced into a particular zone of the formation, a mechanical sand control device is installed in the well bore adjacent the zone. For example, a screen (for example, expandable or traditional) or liner (for example, perforated or slotted) or any similar device known in the art can function with the treatment fluid to control particulates.

For example, in this example, the method disclosed herein is a method of treating a subterranean formation penetrated by a wellbore with a delayed reaction treatment additive to help minimize particulate migration. This example of the method comprises: (a) providing a carrier fluid; (b) providing the delayed reaction treatment additive disclosed above (wherein the delayed reaction treating agent is a delayed reaction consolidating agent); (c) mixing the treatment additive with the carrier fluid to form a treatment fluid; (d) introducing the treatment fluid through the wellbore into a portion of the subterranean formation that includes unconsolidated particulate material and that contains a sufficient amount of clay to break the macro-emulsion and allow the epoxy resin and the hardening agent component to come into contact with one another; and (e) allowing the consolidating agent to at least partially consolidate at least a portion of the unconsolidated particulates in the formation. The consolidating agent includes a plurality of first droplets dispersed in the internal phase, each of the first droplets containing a resin component that includes a water insoluble, liquid, hardenable epoxy resin, and a plurality of second droplets dispersed in the internal phase, each of the second droplets containing a hardening agent component that includes a water insoluble, liquid hardening agent capable of curing the epoxy resin when brought into contact with the resin. The first droplets and the second droplets retain their separate identities and prevent the resin and the hardening agent from reacting until the emulsion breaks.

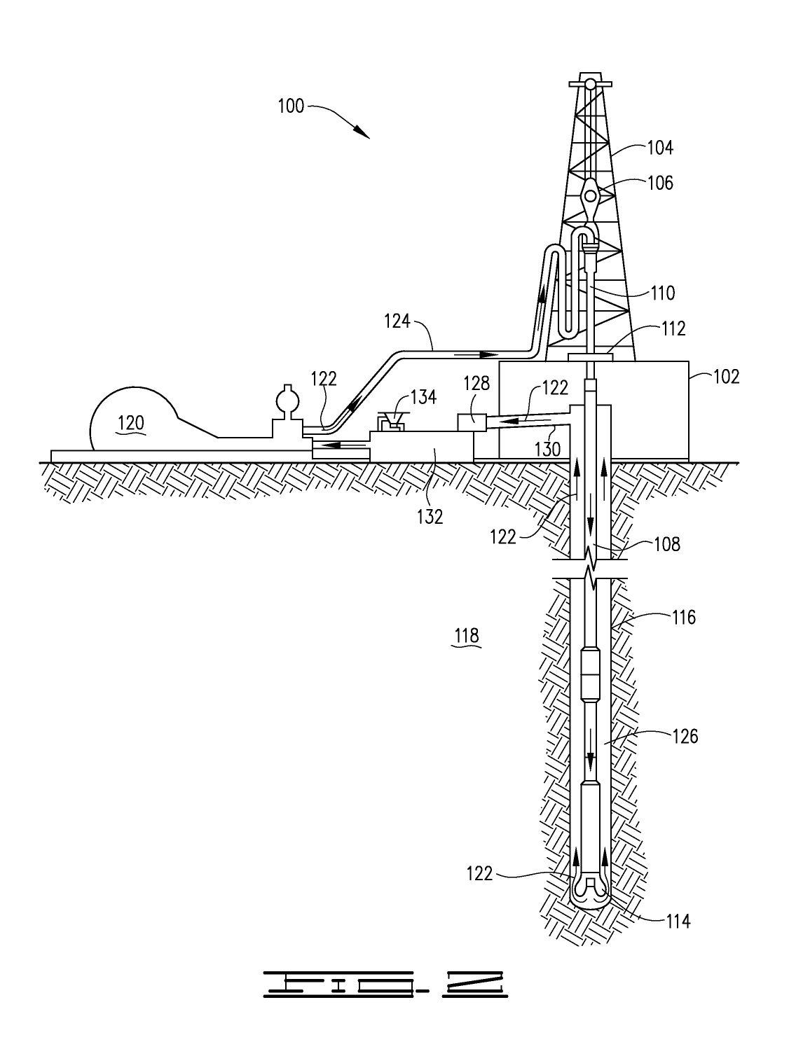

Referring now to the drawings and particularly to FIG. 2, one example of the present method of treating a subterranean formation penetrated by a wellbore with a delayed reaction treatment additive to consolidate unconsolidated particulates therein is generally illustrated and described.

As shown, a water insoluble resin 10 is emulsified into an aqueous liquid 12 (for example, a brine solution) that contains a cationic emulsifier 14 to form a resin emulsion 20. The aqueous liquid 12 forms a continuous phase 22 of the resin emulsion 20. The hardenable resin forms an internal phase 24 of the resin emulsion 20. The resin 10 is emulsified into a plurality of first droplets 26 that are dispersed in the internal phase 24.

Similarly, a water insoluble hardening agent component 30 is emulsified in an aqueous liquid 32 (for example, a brine solution) that contains a cationic emulsifier 34 to form a hardening agent component emulsion 40. The aqueous liquid 32 forms a continuous phase 42 of the hardening agent component emulsion 40. The hardening agent forms an internal phase 44 of the hardening agent component emulsion 40. The hardening agent component 30 is emulsified into a plurality of second droplets 46 that are dispersed in the internal phase 44.

The two emulsions are then physically mixed together to form a clay sensitive dual internal phase macro-emulsion 50. The macro-emulsion 50 includes an internal phase 54 formed of the cationic emulsifiers 14 and 34 and a delayed reaction consolidating agent 56 (comprising the resin and the hardening agent component), and an aqueous-based continuous phase 60 formed of the aqueous liquid 12 and aqueous liquid 32. The first droplets 26 and second droplets 46 retain their separate identities within the internal phase 54 of the macro-emulsion and are prevented from reacting until the macro-emulsion breaks.

The macro-emulsion 50 is then mixed with a carrier fluid (not shown) to form a treatment fluid (not shown). The treatment fluid is then introduced through a wellbore (not shown) placed in clay-containing formation 70. Once in the formation 70, the cationic emulsifiers 14 and 34 (which can be the same) are adsorbed onto surfaces of clay particles. The adsorption of the cationic emulsifiers onto surfaces of clay particles ultimately destabilizes the macro-emulsion 50 and causes it to break. Once the macro-emulsion 50 breaks, the resin and hardening agent components react and consolidate unconsolidated particulates in the formation.

Additional modifications can be made to the disclosed treatment additives and methods depending on the particular application. For example, various additional surfactants that are compatible with the treatment fluid and capable of facilitating the coating of the resin on to particulates in the formation can be optionally added to the aqueous based continuous phase. Such surfactants can also be added to the formation as a preflush fluid. Examples of additional surfactants that can be used include, but are not limited to, alkyl phosphonate surfactants (e.g., C₁₂-C₂₂ alkyl phosphonate surfactants), ethoxylated nonylphenol phosphate ester, nonionic surfactants and amphoteric surfactants. Mixtures of one or more amphoteric and nonionic surfactants also may be suitable. For example, the surfactant or surfactants are included in the aqueous based continuous phase or preflush fluid in an amount in the range of about 1% to about 10% by weight based on the total weight of the hardening agent component.

The treatment additives and methods disclosed herein may be used in connection with the various steps associated with recovering hydrocarbons such as oil and gas from a subterranean formation penetrated by a wellbore. For example, a treatment fluid formed using a consolidating agent can be used as a drill-in fluid in connection with drilling a wellbore through a production zone within the subterranean formation in order to minimize damage. The consolidating agent provides a means for consolidating formations surrounding the wellbore during the drilling phase of the well. For example, such a treatment fluid can be used in lieu of the drilling mud circulated through the well. As another example, a treatment fluid formed using a consolidating agent can be used in completing the well and/or in connection with or after a hydraulic fracturing treatment to consolidate sand and/or other particulate material and help minimize particulate migration.

For example, using the treatment additive disclosed herein, a single component sand consolidation system can be designed in which a dual internal phase macro-emulsion of a resin and a hardening agent component are prepared as a single component system but kept separated until the trigger occurs (for example, the treatment fluid encounters clay in the formation) and the emulsion is broken. The method disclosed herein can eliminate the need to mix the resin and hardener in a proper ratio. It can also eliminate the need for a batch wise mixing procedure and associated mixing tanks since it enables on the fly mixing. The disclosed method can also enable continuous operation of the sand consolidation involving very large volumes of treatment. For example, the method is suitable for continuous treatment of long intervals such as may be encountered in connection with horizontal wells.

When the treating agent is a consolidating agent, the delayed reaction treatment additive disclosed herein is not completely dependent on the type of resin chemistry utilized and does not interfere, for example, in cross-linking reactions involved in the resin system. The broad range of resins and hardening agents that can be used expands the versatility of the disclosed treatment additive and method by allowing a wide range of consolidation strengths and/or other parameters involved in the treatment to be achieved. The delayed reaction treatment additive can be used with aqueous based carrier fluids (for example, water) thereby imparting better environmental ratings and cost effectiveness.

The exemplary chemicals, compounds, additives, agents and fluids (“exemplary components”) disclosed herein may directly or indirectly affect one or more components or pieces of equipment associated with the preparation, delivery, recapture, recycling, reuse, and/or disposal of the disclosed exemplary fluids. For example, and with reference to FIG. 2, the disclosed exemplary fluids may directly or indirectly affect one or more components or pieces of equipment associated with an exemplary wellbore drilling assembly 100, according to one or more examples. It should be noted that while FIG. 2 generally depicts a land-based drilling assembly, those skilled in the art will readily recognize that the principles described herein are equally applicable to subsea drilling operations that employ floating or sea-based platforms and rigs, without departing from the scope of the disclosure.

As illustrated, the drilling assembly 100 may include a drilling platform 102 that supports a derrick 104 having a traveling block 106 for raising and lowering a drill string 108. The drill string 108 may include, but is not limited to, drill pipe and coiled tubing, as generally known to those skilled in the art. A kelly 110 supports the drill string 108 as it is lowered through a rotary table 112. A drill bit 114 is attached to the distal end of the drill string 108 and is driven either by a downhole motor and/or via rotation of the drill string 108 from the well surface. As the bit 114 rotates, it creates a wellbore 116 that penetrates various subterranean formations 118.

A pump 120 (e.g., a mud pump) circulates drilling fluid 122 through a feed pipe 124 and to the kelly 110, which conveys the drilling fluid 122 downhole through the interior of the drill string 108 and through one or more orifices in the drill bit 114. The drilling fluid 122 is then circulated back to the surface via an annulus 126 defined between the drill string 108 and the walls of the borehole 116. At the surface, the recirculated or spent drilling fluid 122 exits the annulus 126 and may be conveyed to one or more fluid processing unit(s) 128 via an interconnecting flow line 130. After passing through the fluid processing unit(s) 128, a “cleaned” drilling fluid 122 is deposited into a nearby retention pit 132 (i.e., a mud pit). While illustrated as being arranged at the outlet of the wellbore 116 via the annulus 126, those skilled in the art will readily appreciate that the fluid processing unit(s) 128 may be arranged at any other location in the drilling assembly 100 to facilitate its proper function, without departing from the scope of the disclosure.

One or more of the disclosed exemplary fluids may be added to the drilling fluid 122 via a mixing hopper 134 communicably coupled to or otherwise in fluid communication with the retention pit 132. The mixing hopper 134 may include, but is not limited to, mixers and related mixing equipment known to those skilled in the art. In other examples, however, the disclosed exemplary fluids may be added to the drilling fluid 122 at any other location in the drilling assembly 100. In at least one example, for example, there could be more than one retention pit 132, such as multiple retention pits 132 in series. Moreover, the retention pit 132 may be representative of one or more fluid storage facilities and/or units where the disclosed exemplary fluids may be stored, reconditioned, and/or regulated until added to the drilling fluid 122.

As mentioned above, the disclosed exemplary fluids may directly or indirectly affect the components and equipment of the drilling assembly 100. For example, the disclosed exemplary fluids may directly or indirectly affect the fluid processing unit(s) 128 which may include, but is not limited to, one or more of a shaker (e.g., shale shaker), a centrifuge, a hydrocyclone, a separator (including magnetic and electrical separators), a desilter, a desander, a filter (e.g., diatomaceous earth filters), a heat exchanger, and any fluid reclamation equipment. The fluid processing unit(s) 128 may further include one or more sensors, gauges, pumps, compressors, and the like used to store, monitor, regulate, and/or recondition the exemplary fluids.

The disclosed exemplary fluids may directly or indirectly affect the pump 120, which representatively includes any conduits, pipelines, trucks, tubulars, and/or pipes used to fluidically convey the exemplary fluids downhole, any pumps, compressors, or motors (e.g., topside or downhole) used to drive the exemplary fluids into motion, any valves or related joints used to regulate the pressure or flow rate of the exemplary fluids, and any sensors (i.e., pressure, temperature, flow rate, etc.), gauges, and/or combinations thereof, and the like. The disclosed exemplary fluids may also directly or indirectly affect the mixing hopper 134 and the retention pit 132 and their assorted variations.

The disclosed exemplary fluids may also directly or indirectly affect the various downhole equipment and tools that may come into contact with the exemplary fluids such as, but not limited to, the drill string 108, any floats, drill collars, mud motors, downhole motors and/or pumps associated with the drill string 108, and any MWD/LWD tools and related telemetry equipment, sensors or distributed sensors associated with the drill string 108. The disclosed exemplary fluids may also directly or indirectly affect any downhole heat exchangers, valves and corresponding actuation devices, tool seals, packers and other wellbore isolation devices, components and the like associated with the wellbore 116. The disclosed exemplary fluids may also directly or indirectly affect the drill bit 114, which may include, but is not limited to, roller cone bits, PDC bits, natural diamond bits, any hole openers, reamers, coring bits, etc.

While not specifically illustrated herein, the disclosed exemplary fluids may also directly or indirectly affect any transport or delivery equipment used to convey the exemplary fluids to the drilling assembly 100 such as, for example, any transport vessels, conduits, pipelines, trucks, tubulars, and/or pipes used to fluidically move the exemplary fluids from one location to another, any pumps, compressors, or motors used to drive the exemplary fluids into motion, any valves or related joints used to regulate the pressure or flow rate of the exemplary fluids, and any sensors (i.e., pressure and temperature), gauges, and/or combinations thereof, and the like.

The following prophetic examples illustrate specific embodiments consistent with the present disclosure but do not limit the scope of the disclosure or the appended claims. Concentrations and percentages are by weight unless otherwise indicated.

### EXAMPLE 1

Composition A is prepared by emulsifying 5 gm of Expedite® 225A in 45 ml of 7% KCl brine containing 2% cetyltrimethylammoniumchloride. For example, cetyltrimethyl-ammoniumchloride is sold by KAO Chemicals in association with the trademark QUARTAMIN® 60. The mixture is stirred for 5 minutes in a Waring blender at a very high speed.

Composition B is separately prepared by emulsifying 5 gm of Expedite® 225B in 45 ml of 7% KCl brine containing 2% cetyltrimethylammonium chloride. The mixture is stirred for 5 minutes in a Waring blender at a very high speed.

Composition A and Composition B are then mixed in a Waring blender at a low speed to form Composition C. Composition C is an example of one embodiment of the delayed reaction treatment additive disclosed herein that is suitable for use in the method disclosed herein.

### EXAMPLE 2

Next, 100 gm of Composition C is stirred with a magnetic stirrer and 5 gm of bentonite clay is added to the mixture. Composition C is broken after mixing for at least 5 minutes into two separate layers allowing the Expedite® 225A and Expedite® 225B to come into contact with one another and react.

### EXAMPLE 3

Composition D is prepared by emulsifying 25 gm of Expedite® 225A in 25 ml of 7% KCl brine containing 20% cetyltrimethylammoniumchloride. The mixture is stirred for 5 minutes in a Waring blender at a very high speed.

Composition E is separately prepared by emulsifying 25 gm of Expedite® 225B in 25 ml of 7% KCl brine containing 20% cetyltrimethylammoniumchloride. The mixture is stirred for 5 minutes in a Warring blender at a very high speed.

Composition D and Composition E are then mixed in a Warring blender at a low speed to form composition F. Composition F can be stored for a longer period before being used to allow for, for example, transportation of the composition.

Next, 80 ml of 7% KCl brine is mixed with 20 ml of Composition F to form composition G. Composition G is an example of another embodiment of the delayed reaction treatment additive disclosed herein that is suitable for use in the method disclosed herein.

### EXAMPLE 4

Next, 100 gm of Composition G is stirred with a magnetic stirrer and 5 gm of bentonite clay is added to the mixture. Composition G is broken after mixing for at least 5 minutes into two separate layers allowing the Expedite® 225A and Expedite® 225B to come into contact with one another and react.

For example, Composition A and Composition B can be mixed on the fly with a 7% brine solution as the components are introduced into the wellbore and placed into the formation. Similarly, Composition D and Composition E can be mixed on the fly with a 7% brine solution as the components are introduced into the wellbore and placed into the formation. As another example, Composition F can be mixed with the carrier fluid on the fly and placed in the formation.

### EXAMPLE 5

The delayed reaction treatment additive disclosed herein is used to treat a subterranean formation penetrated by a wellbore to help minimize particulate migration. The internal phase of the clay sensitive multi-phase macro-emulsion of the treatment additive includes a consolidating agent. The consolidating agent includes a plurality of first droplets dispersed in the internal phase, each of the first droplets including Expedite® 225A, and a plurality of second droplets dispersed in the internal phase, each of the second droplets including Expedite® 225B.

The delayed reaction treatment additive is mixed with a carrier fluid (a 7% KCl brine solution) on the fly to form a treatment fluid that is injected into the wellbore and placed in a zone of the formation that includes unconsolidated sand and that contains a sufficient amount of clay to break the macro-emulsion and allow the Expedite® 225A and Expedite® 225B to come into contact with another. The treatment additive is used in an amount sufficient to consolidate at least a portion of the unconsolidated sand in the zone of interest. The macro-emulsion remains stable as it is pumped through the wellbore but begins to destabilize once it encounters clay in the zone. The zone is then shut in for a sufficient amount of time to allow the Expedite® 225A resin to cure and at least partially consolidate a portion of the sand in the zone.

Therefore, the present treatment additives and methods are well adapted to attain the ends and advantages mentioned, as well as those that are inherent therein. The particular prophetic examples disclosed above are illustrative only, as the present treatment additives and methods may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative prophetic examples disclosed above may be altered or modified, and all such variations are considered within the scope and spirit of the present treatment additives and methods. While compositions and methods are described in terms of “comprising,” “containing,” “having,” or “including” various components or steps, the compositions and methods can also, in some examples, “consist essentially of” or “consist of” the various components and steps. Whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee.

What is claimed is:

1. A delayed reaction treatment additive for treating a subterranean formation penetrated by a wellbore, comprising:
a clay sensitive multi-internal phase macro-emulsion formed using a cationic emulsifier and having an internal phase and an aqueous-based continuous phase, said internal phase including a delayed reaction treating agent, said treating agent including:
a plurality of first droplets dispersed in said internal phase, each of said first droplets containing a water insoluble, first component; and
a plurality of second droplets dispersed in said internal phase, each of said second droplets containing a water insoluble, second component capable of reacting with said first component.

2. The treatment additive of claim 1, wherein said macro-emulsion is prepared by:
preparing a first oil in water emulsion by emulsifying a water insoluble, liquid first component in a first aqueous liquid containing a cationic emulsifier;
preparing a second oil in water emulsion by emulsifying a water insoluble, liquid second component capable of reacting with said first component in a second aqueous liquid containing a cationic emulsifier, said first aqueous solution and said second aqueous solution being compatible with one another; and
mixing said first emulsion and said second emulsion together.

3. The treatment additive of claim 2, wherein said first aqueous liquid and said second aqueous liquid are the same.

4. The treatment additive of claim 3, wherein said first aqueous liquid and second aqueous liquid are each a brine solution.

5. The treatment additive of claim 2, wherein said cationic emulsifier contained by said first aqueous liquid and said second aqueous liquid is a quaternary ammonium salt.

6. The treatment additive of claim 2, wherein said cationic emulsifier contained by said first aqueous liquid and cationic emulsifier contained by said second aqueous liquid are the same.

7. The treatment additive of claim 1, wherein said cationic emulsifier is a quaternary ammonium salt.

8. A delayed reaction treatment additive for treating a subterranean formation penetrated by a wellbore, comprising:
a clay sensitive multi-internal phase macro-emulsion formed using a cationic emulsifier and having an internal phase and an aqueous-based continuous phase, said internal phase including a delayed reaction consolidating agent, said consolidating agent including:
a plurality of first droplets dispersed in said internal phase, each of said first droplets containing a resin component that includes a water insoluble, hardenable epoxy resin; and
a plurality of second droplets dispersed in said internal phase, each of said second droplets containing a hardening agent component that includes a water insoluble hardening agent capable of curing said epoxy resin when brought into contact with said resin.

9. The treatment additive of claim 8, wherein said water insoluble hardenable epoxy resin is a liquid epoxy resin selected from the group consisting of bisphenol A-epichlorohydrin resins, glycerol diglycidyl ether, 1,1,1-trimethylolpropane polyglycidyl ether, and mixtures thereof.

10. The treatment additive of claim 9, wherein said water insoluble, hardenable epoxy resin is a bisphenol A-epichlorohydrin resin.

11. The treatment additive of claim 8, wherein said resin component further comprises a solvent.

12. The treatment additive of claim 8, wherein said water insoluble hardening agent is a liquid hardening agent comprising a cyclo-aliphatic amine.

13. The treatment additive of claim 12, wherein said water insoluble hardening agent is selected from the group of modified piperazines, aminoethylpiperazine, and mixtures thereof.

14. A method of treating a subterranean formation penetrated by a wellbore with a delayed reaction treatment additive, comprising:
providing a carrier fluid;
providing a delayed reaction treatment additive, said treatment additive including:
a clay sensitive multi-internal phase macro-emulsion formed using a cationic emulsifier and having an internal phase and an aqueous-based continuous phase, said internal phase including a delayed reaction treating agent, said treating agent including:
a plurality of first droplets dispersed in said internal phase, each of said first droplets containing a water insoluble first component; and
a plurality of second droplets dispersed in said internal phase, each of said second droplets containing a water insoluble second component capable of reacting with said first component;
mixing said treatment additive with said carrier fluid to form a treatment fluid;
introducing said treatment fluid into the wellbore and placing said treatment fluid into a portion of the subterranean formation to be treated that contains a sufficient amount of clay to break said macro-emulsion and allow said first component and said second component to come into contact with one another; and
allowing said treating agent to treat the formation.

15. The method of claim 14, wherein said carrier fluid and said treating agent are mixed together on the fly to form said treatment fluid as said treatment fluid is introduced into said wellbore.

16. The method of claim 14, wherein said treatment additive is mixed with said carrier fluid to form said treatment fluid in an amount in the range of from about 0.1% (w/v) to about 25% (w/v) of said carrier fluid.

17. The method of claim 14, wherein said treating agent is a consolidating agent, said water insoluble, first component is a resin component that includes a water insoluble, liquid epoxy resin, and said second component is a hardening agent component that includes a water insoluble, liquid hardening agent capable of curing said epoxy resin when brought into contact with said resin.

18. The method of claim 17, wherein said carrier fluid and said consolidating agent are mixed together on the fly to form said treatment fluid as said treatment fluid is introduced into said wellbore.

19. The method of claim 17, wherein said treatment additive is mixed with said carrier fluid to form said treatment fluid in an amount in the range of from about 0.1% (w/v) to about 25% (w/v) of said carrier fluid.

20. The method of claim 17, wherein said treatment fluid is used as a drill-in fluid and introduced through said wellbore into a portion of the subterranean formation that includes unconsolidated particulate material by pumping said treatment fluid through a feed pipe and to a kelly, which conveys the treatment fluid downhole through the interior of a drill string and through one or more orifices in a drill bit.
